(19) United States
(12) Patent Application Publication
(10) Pub. No.: US 2019/0111930 A1
(43) Pub. Date: Apr. 18, 2019

(54) VEHICLE CONTROLLER

(71) Applicant: TOYOTA JIDOSHA KABUSHIKI KAISHA, Toyota-shi (JP)

(72) Inventors: Yoichiro KATSURA, Susono-shi (JP); Yoshinori WATANABE, Isehara-shi (JP)

(73) Assignee: TOYOTA JIDOSHA KABUSHIKI KAISHA, Toyota-shi (JP)

(21) Appl. No.: 16/118,609

(22) Filed: Aug. 31, 2018

(30) Foreign Application Priority Data
Oct. 18, 2017 (JP) 2017-202056

(51) Int. Cl. B60W 30/18; B60W 30/095; B60W 30/09; G05D 1/00; G06K 9/00

(52) U.S. Cl. CPC B60W 30/18154; B60W 30/18163; B60W 30/0956; B60W 30/09; B60W 2550/10; G06K 9/00805; G05D 2201/0213; B60W 2550/22; B60W 2550/141; G05D 1/0088

(57) ABSTRACT

A vehicle controller for a vehicle that is able to travel autonomously in a junction at which a traveling lane and another lane join, the vehicle controller includes an electronic control unit configured to: acquire constraint condition information on traffic constraint conditions that are imposed on a vehicle entering the junction; perform a priority determining process of determining priorities of the traveling lane and the other lane in the junction based on the constraint condition information, perform a behavior determining process of determining whether to cause a host vehicle to precede another vehicle traveling on the other lane based on the priorities; and control the host vehicle based on the constraint condition information.

### INCORPORATION BY REFERENCE

The disclosure of Japanese Patent Application No. 2017-202056 filed on Oct. 18, 2017 including the specification, drawings and abstract is incorporated herein by reference in its entirety.

### BACKGROUND

### 1. Technical Field

The disclosure relates to a vehicle controller.

### 2. Description of Related Art

In the related art, as described in Japanese Unexamined Patent Application Publication No. 2017-132408 (JP 2017-132408 A), a vehicle controller that controls the behavior of a host vehicle traveling toward a junction at which a traveling lane and another lane merge such that another vehicle traveling on the other lane toward the junction enters the traveling lane either in front of or behind the host vehicle is known.

In the vehicle controller, a deceleration of the host vehicle which is necessary for the other vehicle to merge in front of the host vehicle and a deceleration of the other vehicle which is necessary for the other vehicle to merge behind the host vehicle are calculated. When the deceleration necessary for the host vehicle is smaller than the deceleration necessary for the other vehicle, control is performed such that an operation of decelerating the host vehicle is performed such that the other vehicle enters the traveling lane in front of the host vehicle. On the other hand, when the deceleration necessary for the host vehicle is greater than the deceleration necessary for the other vehicle, control is performed such that an operation of notifying the other vehicle is performed such that the other vehicle enters the traveling lane behind the host vehicle. That is, in the vehicle controller, the behavior of the host vehicle is controlled such that whichever of the host vehicle and the other vehicle having a smaller necessary deceleration decelerates.

### SUMMARY

As described above, control based on a relative relationship between a host vehicle and another vehicle which is performed in a junction is described in JP 2017-132408 A. However, which of the host vehicle and the other vehicle has a priority in the junction is not determined based on only the relative relationship between the host vehicle and the other vehicle. Accordingly, in the technique described in JP 2017-132408 A, there is a likelihood that whether the host vehicle should precede the other vehicle at the junction will not be appropriately determined.

The disclosure provides a vehicle controller that can realize a smooth traffic flow at a junction by appropriately determining whether a host vehicle should precede another vehicle.

A vehicle controller according to an aspect of the disclosure is for a vehicle that is able to travel autonomously in a junction at which a traveling lane and another lane join. The vehicle controller includes an electronic control unit configured to: acquire constraint condition information on traffic constraint conditions that are imposed on a vehicle entering the junction; perform a priority determining process of determining priorities of the traveling lane and the other lane in the junction based on the constraint condition information, perform a behavior determining process of determining whether to cause a host vehicle to precede another vehicle traveling on the other lane based on the priorities; and control the host vehicle based on the constraint condition information.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram illustrating a configuration of a vehicle controller according to an embodiment of the disclosure;

FIG. 2 is a diagram illustrating a definition of a junction;

FIG. 3A is a diagram illustrating a first example of a white line on a road surface indicating traffic regulations for a junction;

FIG. 3B is a diagram illustrating a second example of a white line on a road surface indicating traffic regulations for a junction;

FIG. 3C is a diagram illustrating a third example of a white line on a road surface indicating traffic regulations for a junction;

FIG. 4A is a diagram illustrating a first example of a road signboard indicating traffic regulations for a junction;

FIG. 4B is a diagram illustrating a second example of a road signboard indicating traffic regulations for a junction;

FIG. 5 is a diagram illustrating an example of a road surface marking indicating traffic regulations for a junction;

FIG. 6 is a diagram illustrating an example of a road shape in a junction;

FIG. 7A is a diagram illustrating a first example of a road shape in a junction;

FIG. 7B is a diagram illustrating a second example of a road shape in a junction;

FIG. 8 is a diagram illustrating an example of a lane structure before a junction;

FIG. 9 is a flowchart illustrating an example of a main routine of joining control which is performed by an ECU;

FIG. 10 is a flowchart illustrating an example of a subroutine which is read from Step S1 of the main routine;

FIG. 11 is a flowchart illustrating an example of a subroutine which is read from Step S3 of the main routine;

FIG. 12 is a flowchart illustrating an example of a subroutine which is read from Step S4 of the main routine; and

FIG. 13 is a flowchart illustrating an example of a subroutine which is read from Step S5 of the main routine.

### DETAILED DESCRIPTION OF EMBODIMENTS

Hereinafter, an embodiment of the disclosure will be described with reference to the accompanying drawings.

### 1. Configuration of Vehicle Controller

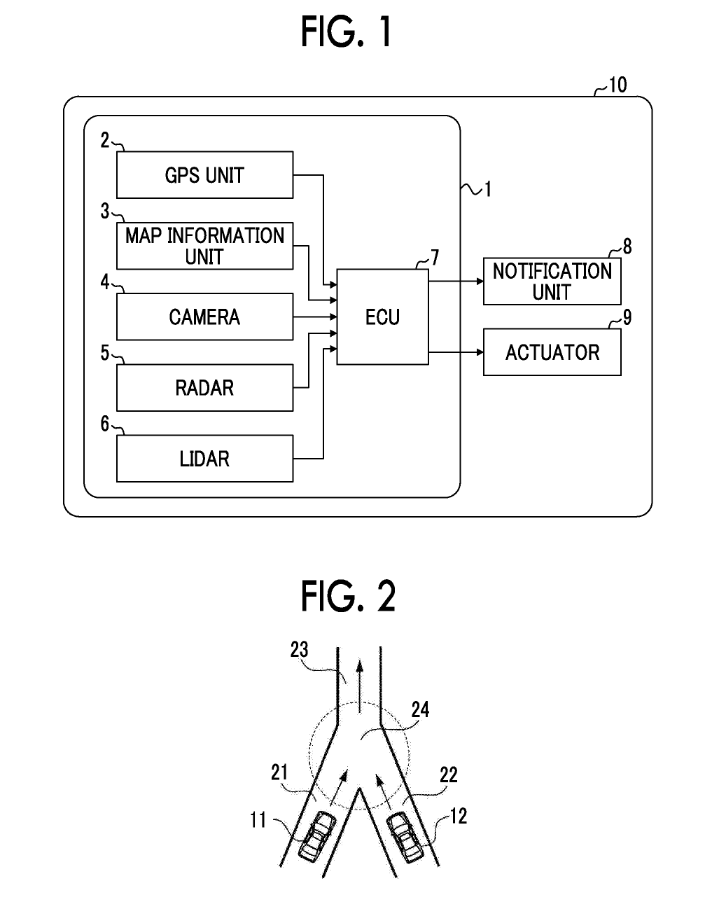

A vehicle controller according to an embodiment of the disclosure is, for example, a vehicle controller that can realize an automatic driving level equal to or higher than level 2 in the definition of level in the Society of Automotive Engineers (SAE). The configuration of the vehicle controller according to the embodiment of the disclosure can be expressed in a block diagram as illustrated in FIG. 1.

As illustrated in FIG. 1, a vehicle 10 includes an electronic control unit (ECU) 7, a GPS unit 2 that is electrically connected to the ECU 7, a map information unit 3, a camera 4, a radar 5, a LIDAR 6, a notification unit 8, and an actuator 9. In this embodiment, the vehicle controller 1 is constituted by the GPS unit 2, the map information unit 3, the camera 4, the radar 5, the LIDAR 6, and the ECU 7.

The GPS unit 2 is means that acquires position information indicating a current location of a host vehicle based on GPS signals. The ECU 7 can ascertain the current location of a vehicle 10 based on the position information provided from the GPS unit 2. The map information unit 3 is formed, for example, in a storage device such as an HDD or an SSD which is mounted in the vehicle. Map information in the map information unit 3 includes a variety of information such as a position of a road, a shape of a road, a lane structure, and traffic regulations associated with a road.

The camera 4, the radar 5, and the LIDAR 6 are external sensors that acquire information on external conditions of the vehicle 10. The camera 4 images, for example, surroundings of the vehicle 10 including at least the front in the traveling direction of the vehicle 10, and transmits image information acquired by the imaging to the ECU 7. The ECU 7 can recognize a road signboard, a road surface marking, and a lane including white lines which are present in front in the traveling direction of the vehicle 10 by performing known image processing on the image information transmitted from the camera 4. Here, a lane may indicate a section of a one vehicle width for automobile travel which is formed on a road by white lines, obstacles or the like.

The radar 5 is a millimeter wave radar device which is mounted in the vehicle 10. Other vehicle information including a relative position and a relative speed between another vehicle and the vehicle 10 is transmitted from the radar 5 to the ECU 7. The LIDAR 6 is a laser imaging detection and ranging (LIDAR) device which is mounted in the vehicle 10. Other vehicle information including at least a relative position between another vehicle and the vehicle 10 is transmitted from the LIDAR 6 to the ECU 7. The ECU 7 can recognize a relative position or a relative speed of another vehicle or another object which is present near the vehicle 10 based on the other vehicle information transmitted from the radar 5 or the LIDAR 6.

The ECU 7 is a computer that includes at least one processor and at least one memory. Various data including a map or various programs are stored in the memory. By causing the processor to read and execute a program stored in the memory, the ECU 7 embodies various functions. The ECU 7 performs a behavior determining process which will be described later based on map information acquired from the map information unit 3 and/or image information acquired from the camera 4. The ECU 7 transmits a control command value to the notification unit 8 and the actuator 9 based on a result of the behavior determining process which will be described later. The ECU 7 constituting the vehicle controller 1 may be a set of a plurality of ECUs.

The notification unit 8 notifies another vehicle located near the vehicle 10 of information for behavior determination of the vehicle 10 based on a control command value transmitted from the ECU 7. In this embodiment, the notification unit 8 is a winker or a hazard lamp which is an indicator which can be visually recognized from the outside. However, the notification unit 8 is not limited thereto as long as it can notify another vehicle of information for behavior determination of the vehicle 10. For example, the notification unit 8 may be configured as a device that can be visually recognized due to optical flickering of a display or may be configured as a device that can be aurally recognized due to sound from a speaker. The notification unit may be configured as a device that notifies another vehicle of information by communication between vehicles.

The actuator 9 operates based on a control command value transmitted from the ECU 7. The actuator 9 includes, for example, an acceleration actuator that is used to accelerate the vehicle 10, a deceleration actuator that is used to decelerate the vehicle 10, and a steering actuator that steers the vehicle 10, and can change acceleration/deceleration and a steering angle of the vehicle 10. An example of the acceleration actuator is an engine and/or a motor as a power generating device. An example of the deceleration actuator is a hydraulic brake and/or a regenerative brake. An example of the steering actuator is a power steering system using a motor or a hydraulic pressure.

The ECU 7 can control the actuator 9 such that the vehicle 10 travels automatically in a junction at which a traveling lane and another lane join. Definitions of a junction in this specification will be described below with reference to FIG. 2. In FIG. 2, an example in which two lanes 21 and 22 merge to form one lane 23 is illustrated. In FIG. 2, an area (that is, an area surrounded with a dotted line) within a predetermined distance before and after a point at which the two lanes 21 and 22 merge is a junction 24. This area includes both the lanes 21 and 22 approaching the joining point. The predetermined distance for determining that area changes depending on vehicle speeds of vehicles 11 and 12 traveling on the lanes 21 and 22 (at least a vehicle speed of a host vehicle). Here, the predetermined distance may be a fixed value or may be a value which is determined in the map information for each point in advance.

In automatic traveling in a junction, it is important to determine which of a traveling lane on which the host vehicle is traveling and the other lane has a higher priority. The ECU 7 determines the priorities using constraint conditions which are imposed upon the lanes approaching the junction as a basis for determination.

### 2. Description of Constraint Conditions

Constraint conditions in this specification traffic are constraint conditions which are imposed upon vehicles traveling in a junction uniformly and in due course and include legal constraint conditions and physical constraint conditions. The legal constraint conditions are specifically traffic regulations for a junction. The physical constraint conditions include a road shape of the junction, a shape of the junction which is formed on a road, a lane structure before the junction, and the like. Information on the constraint conditions may be included in map information acquired from the map information unit 3 or may be included in image information acquired from the camera 4. That is, the map information unit 3 and the camera 4 are examples of a constraint condition information acquiring unit (constraint condition information acquiring device.) The ECU 7 acquires the constraint conditions by using the constraint condition information acquiring unit. Examples of the legal constraint conditions and the physical constraint conditions will be described below with reference to the drawings.

First, an example of the legal constraint conditions will be described. Traffic regulations associated with a junction, which are the legal constraint conditions, are regulations associated with a duty to stop, a duty for slow movement, a duty of care, a priority of passing, and the like. Information on traffic regulations is included in the map information stored in the map information unit 3. Therefore, the information on traffic regulations for a junction can be acquired from the map information by searching a database of the map information unit 3.

Information on traffic regulations appears on road facility in an actual space. Road facility mentioned herein is infrastructure installed on roads and is a generic name for infrastructure indicating traffic regulations such as a road surface marking, a road defining line, a stop line, and a road signboard. Since these can be imaged by the camera 4, the information on traffic regulations for a junction can be acquired by extracting road facility from image information of the camera 4.

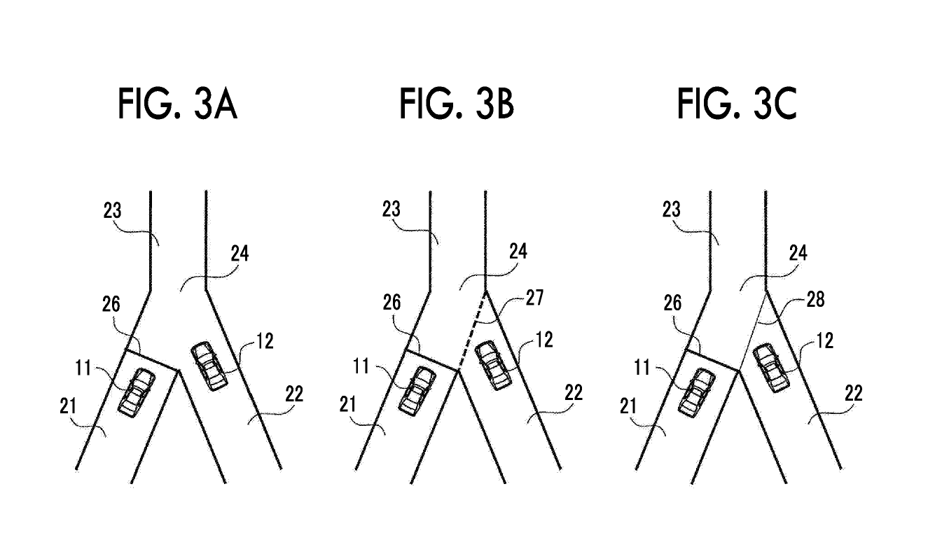

FIGS. 3A, 3B, and 3C illustrate examples of white lines of a road surface indicating traffic regulations for a junction. Presence of a stop line or a road defining line may be acquired from the map information or may be acquired by performing image processing on the image information of the camera 4.

In the road illustrated in FIG. 3A, a solid line 26 crossing a lane is drawn on a left lane 21. Information on traffic regulations indicated by this is a duty to stop for a vehicle 11 which is traveling on the left lane 21. On the other hand, there is no line crossing a lane in a right lane 22. Information on traffic regulations indicated by this is that a vehicle 12 traveling on the right lane 22 has no duty to stop. By synthesizing this information, it can be determined that the right lane 22 has a higher priority in the junction 24.

In the road illustrated in FIG. 3B, a solid line 26 crossing a lane is drawn on the left lane 21. Information on traffic regulations indicated by this is a duty to stop of the vehicle 11 which travels on the left lane 21. On the other hand, a dotted line 27 crossing a lane is drawn on the right lane 22. Information on traffic regulations indicated by this is a duty of care for a vehicle 12 which travels on the right lane 22. By synthesizing this information, it can be determined that the right lane 22 has a higher priority in the junction 24.

In the road illustrated in FIG. 3C, solid lines 26 and 28 crossing a lane are drawn on both the left lane 21 and the right lane 22. The solid line 28 on the right lane 22 is thinner than the solid line 26 on the left lane 21. When the thickness of a stop line is defined to indicate a strength of a duty to stop, it can be determined that the right lane 22 has a higher priority in the junction 24 from the relationship between thicknesses of the solid lines 26 and 28.

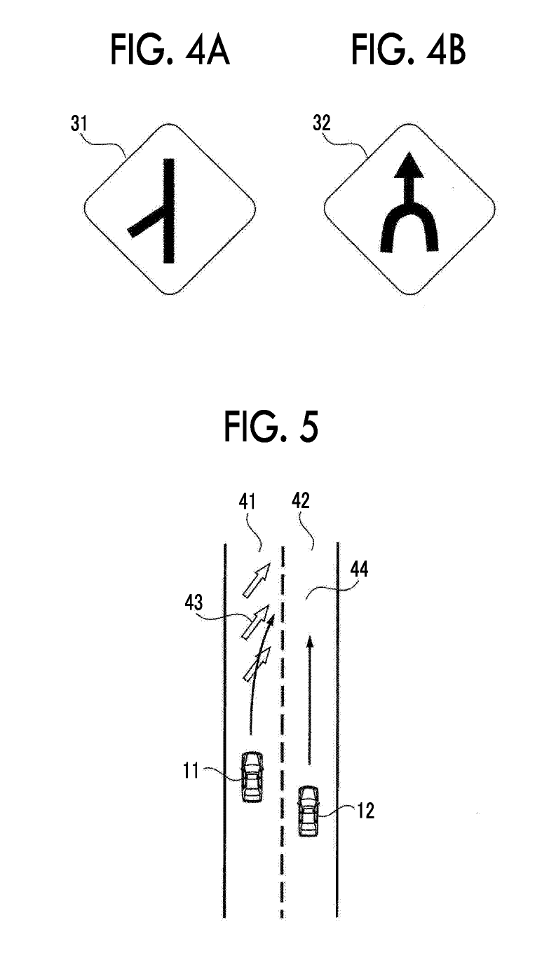

FIGS. 4A and 4B illustrate examples of a road signboard indicating traffic regulations for a junction. Presence of a road signboard may be acquired from the map information or may be acquired by image processing on the image information of the camera 4.

A road signboard 31 illustrated in FIG. 4A indicates that there is a joining intersection in which the other lane joins the traveling lane in front in the traveling direction. Information on traffic regulations indicated by this road signboard 31 is a duty of care of a vehicle traveling on the traveling lane for the other lane. From traffic regulation information indicated by the road signboard 31, it can be determined that the traveling lane has a higher priority in the junction.

On the other hand, a road signboard 32 illustrated in FIG. 4B indicates that there is a joining intersection in which the traveling lane and the other lane merge on equal terms with each other in front in the traveling direction. From traffic regulation information indicated by the road signboard 32, it can be determined that the traveling lane and the other lane have the same priority in the junction.

FIG. 5 illustrates an example of a road surface marking indicating traffic regulations for the junction. Presence of this road surface marking may be acquired from the map information or may be acquired by performing image processing on the image information of the camera 4.

In FIG. 5, arrows 43 are drawn on a left lane 41 of a road with two lanes on each side. The arrows 43 are drawn in a direction inclined to the right lane 42 with respect to the extending direction of a left lane 41 in a junction 44 in which the left lane 41 joins to the right lane 42. Information on traffic regulations indicated by these arrows 43 is that the lane 41 on which the arrows 43 are drawn is a joining lane and the nearby lane 42 indicated by the arrows 43 is a main lane. From traffic regulation information indicated by the arrows 43, it can be determined that the right lane 42 has a higher priority in the junction 44.

An example of the physical constraint conditions will be described below. A road shape of a junction which is an example of the physical constraint conditions specifically refers to a way in which two joining lanes approach each other. The road shape including a junction includes a road shape in which one lane approaches and joins the other lane and a road shape in which two lanes join by approaching each other on equal terms. When there is a difference in a way of approach between joining lanes, a degree of steering or a degree of deceleration of a vehicle is likely to be greater in an approaching lane than in an approached lane. Therefore, it may be considered that the approached lane has a higher priority than the approaching lane.

A permanent road shape including a junction is included in the map information stored in the map information unit 3. Therefore, by searching a database of the map information unit 3, information on a road shape of a junction can be acquired. Depending on traveling conditions of the vehicle 10, the information on a road shape of a junction may be acquired by imaging processing on image information from the camera 4. A temporary road shape which is formed by installation of pylons or the like can be acquired from image information of the camera 4. According to this embodiment, even when a joined lane is temporarily formed due to a roadwork or an accident on a road having a plurality of lanes which is not a joined road normally, it is possible to determine priorities.

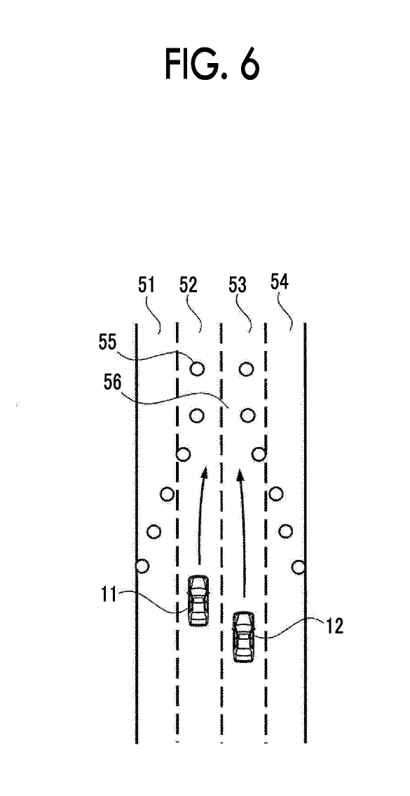

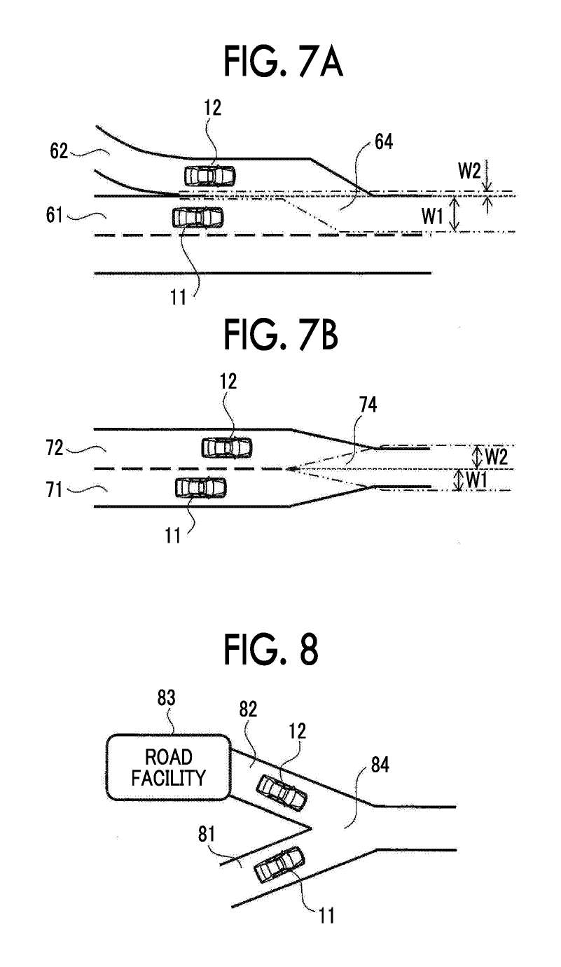

In FIG. 6, an example in which a plurality of pylons 55 are installed on a road with four lanes on each side and the number of lanes is decreased from four lanes to one lane by the pylons 55 is illustrated. In this example, since a road shape (a shape of a junction) formed by the pylons 55 symmetrically narrows from both sides, a lane 53 on which a right vehicle 12 travels and a lane 52 on which a left vehicle 11 travels approach each other in the same way. Accordingly, from this road shape, it can be determined that the right lane 53 and the left lane 52 have the same priority in the junction 56. In this embodiment, the road shape formed by the pylons 55 symmetrically narrows on both sides, but it may be a shape illustrated in FIG. 7A which will be described later. In this embodiment, a joined road is formed by the pylons 55, but a joined road may be formed by obstacles (for example, poles or fences) other than the pylons 55.

A method of determining a road shape of a junction, more specifically, determining a way in which two joining lanes approach each other, will be described below with reference to FIGS. 7A and 7B. Road shapes (shapes of junctions) illustrated in FIGS. 7A and 7B may be formed by white lines drawn on a road surface or may be formed by obstacles such as pylons. When determination of a way of approach is performed, first, a distance W1 between a straight line or a curve obtained by extending a boundary line between a traveling lane and another lane and the boundary line on the other lane side on the traveling lane and a distance W2 between the straight line or the curve obtained by extending the boundary line between the traveling lane and the other lane and the boundary line on the traveling lane side on the other lane are calculated. The boundary line on the other lane side is a line on the side opposite to that on which the other vehicle 12 joins when looking forward in the traveling direction from the host vehicle 11 among the lines indicating both sides in the vehicle width direction of the joined lane. The boundary line on the traveling lane side may be a line on the side on which the other vehicle 12 joins when the host vehicle 11 sees the front in the traveling direction among the lines indicating both ends in the vehicle width direction of the joined lane. After the two distances W1 and W2 are calculated, the two distances W1 and W2 are compared. In FIGS. 7A and 7B, a straight line or a curve obtained by extending the boundary line between the traveling lane on which the host vehicle 11 travels and the other lane on which the other vehicle 12 travels is drawn as a solid line, the boundary line on the other lane side on the traveling lane is drawn as an alternate long and two short dashes line, and the boundary line on the traveling lane side on the other lane is drawn as an alternate long and short dashes line.

In the example illustrated in FIG. 7A, the distance W1 is larger than the distance W2. This means that the road shape of the junction 64 is a road shape in which the other lane 62 on which the other vehicle 12 travels joins to approach the traveling lane 61 on which the host vehicle 11 travels. That is, the traveling lane 61 is a main lane and the other lane 62 is a joining lane. Accordingly, it can be determined from the road shape that the traveling lane 61 on which the host vehicle 11 travels has a higher priority in the junction 64.

On the other hand, in the example illustrated in FIG. 7B, the distance W2 and the distance W1 are equal to each other. This means that the road shape of the junction 74 is a road shape in which the traveling lane 71 on which the host vehicle 11 travels and the other lane 72 merge to approach each other on equal terms. Accordingly, it can be determined from this road shape that the traveling lane 71 and the other lane 72 have the same priority in the junction 74. When a lane boundary line of one of the traveling lane and the other lane is not present in the map information nor in the image information, a position obtained by adding a lane width to the other lane can be set as the lane boundary line of the lane.

The lane structure before the junction which is an example of the physical constraint conditions specifically refers to road facility which is connected to the lane before the junction. Road facility specifically is road facility in an expressway or a motorway and includes, for example, a service area, a parking area, an interchange, and a bust stop. In a lane extending from such road facility, a vehicle speed when entering the junction is likely to be lower than in a lane not extending from the road facility (that is, a main lane). Accordingly, a lane extending from road facility to the junction may be considered to have a lower priority than the other lane.

The exemplified road facility are included in the map information stored in the map information unit 3. Accordingly, it is possible to acquire information on a lane structure before a junction by searching a database of the map information unit 3. Depending on traveling environments of the vehicle 10, information on a lane structure before a junction may be acquired by image processing on image information from the camera 4.

In the example illustrated in FIG. 8, the traveling lane 81 on which the host vehicle 11 travels and the other lane 82 on which the other vehicle 12 travels merge in a junction 84. The other lane 82 extends from road facility 83 to the junction 84. From this lane structure, it can be determined that the traveling lane 81 not extending from such road facility has a higher priority in the junction 84 than the other lane 82 extending from the road facility 83.

### 3. Basic Operation of Vehicle Controller

A driver of a vehicle can request the ECU 7 for automatic driving control including vehicle control for joining (hereinafter referred to as joining control) using an input interface which is not illustrated. During execution of automatic driving control, the ECU 7 acquires map information associated with the current location of the vehicle 10 from the map information unit 3 based on position information supplied from the GPS unit 2. The ECU 7 also acquires image information which is acquired by imaging surroundings of the vehicle 10 with the camera 4 from the camera 4. Information on traffic constraint conditions which are imposed upon a vehicle entering the junction is extracted from the map information and/or the image information. The ECU 7 acquires information on a relative relationship between the other vehicle traveling near the vehicle 10 and the vehicle 10 based on information supplied from the radar 5 or the LIDAR 6. The radar 5 and the LIDAR 6 are examples of an “other vehicle information acquiring unit” (a first sensor) or an “obstacle information acquiring unit” (a second sensor.)

The ECU 7 determines whether there is a junction in the traveling direction of the vehicle 10 based on the map information acquired from the map information unit 3. More specifically, it is determined whether a junction will appear within a predetermined distance or a predetermined time from the current location of the vehicle 10. When it is determined that a junction is present in the traveling direction of the vehicle 10, the ECU 7 performs joining control. In the joining control, the ECU 7 determines priorities of the traveling lane on which the vehicle 10 travels and the other lane based on the acquired information on constraint conditions. Then, the ECU 7 performs a process of determining whether the host vehicle is to precede the other vehicle based on the priorities of the traveling lane and the other lane and the information on the relative relationship between the other vehicle traveling on the other lane and the host vehicle, and transmits a control command value to the actuator 9 based on the determination result. Details of the joining control will be described below.

### 4. Processes Associated with Joining Control

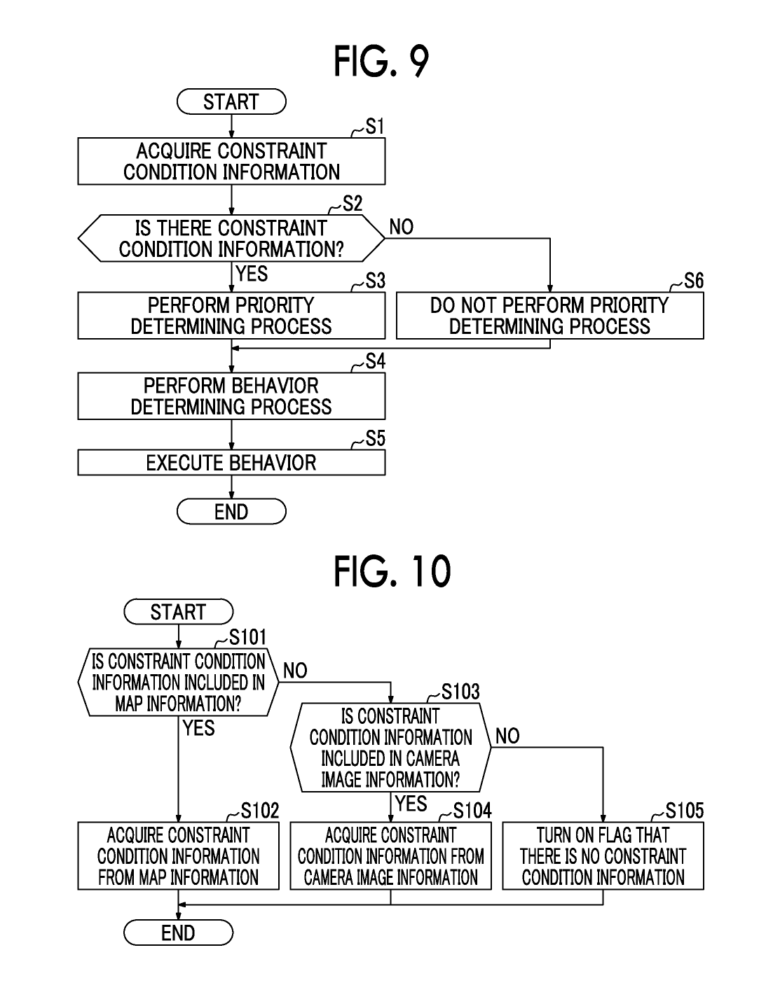

FIG. 9 is a flowchart illustrating an example of a joining control routine (a main routine) which is performed by the ECU 7. The routine illustrated in FIG. 9 is performed in a situation in which the traveling lane on which the vehicle 10 travels and the other lane join.

When the routine illustrated in FIG. 9 is started, information on constraint conditions required for priority determination is acquired in Step S1. Specifically, in Step S1, a subroutine illustrated in FIG. 10 is performed by the ECU 7. The subroutine illustrated in FIG. 10 is an example of a process of acquiring constraint condition information which is performed in Step S1.

In the subroutine illustrated in FIG. 10, first, in Step S101, map information acquired from the map information unit 3 is searched and it is determined whether information on constraint conditions is included in the map information.

When information on constraint conditions is included in the map information, the process of Step S102 is performed. In Step S102, information on constraint conditions required for priority determination is acquired from the map information acquired from the map information unit 3. Accordingly, the process of Step S1 in the main routine ends.

On the other hand, when information on constraint conditions is not included in the map information, the process of Step S103 is performed. In Step S103, image processing is performed on image information acquired from the camera 4 and it is determined whether information on constraint conditions is included in the image information.

When information on constraint conditions is included in the image information, the process of Step S104 is performed. In Step S104, information on constraint conditions required for priority determination is acquired from the image information acquired from the camera 4. Accordingly, the process of Step S1 in the main routine ends.

On the other hand, when information on constraint conditions is not included in the image information, the process of Step S105 is performed. In Step S105, a flag indicating that there is no information on constraint conditions required for priority determination is turned on. Accordingly, the process of Step S1 in the main routine ends.

Processes of Step S2 and steps subsequent thereto will be described below with reference back to the main routine illustrated in FIG. 9. In Step S2, it is determined whether there is no information constraint conditions required for priority determination. Whether there is no information on constraint conditions can be determined depending on whether the flag is turned on in Step S105 of the subroutine illustrated in FIG. 10.

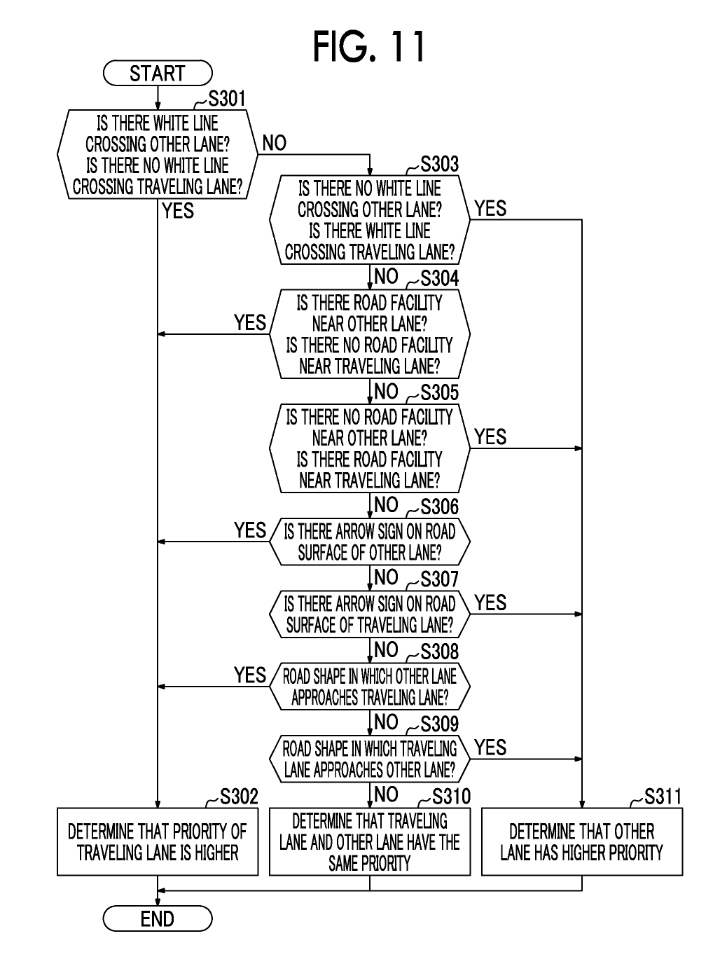

When it is determined in Step S2 that there is information on constraint conditions required for priority determination, a priority determining process is performed in Step S3. Specifically, in Step S3, a subroutine illustrated in FIG. 11 is performed by the ECU 7. The subroutine illustrated in FIG. 11 is an example of the priority determining process which is performed in Step S3.

In the subroutine illustrated in FIG. 11, first, in Step S301, information on traffic regulations of a junction in the information on constraint conditions acquired in Step S1 is referred to. It is determined whether condition that there is a white line (a stop line) crossing a lane in the other lane and there is no white line crossing a lane in the traveling lane is satisfied.

When the condition is satisfied in Step S301, that is, when there is a white line crossing a lane in only the other lane, the process of Step S302 is performed. In Step S302, it is determined that the traveling lane has a higher priority than the other lane. Accordingly, the process of Step S3 in the main routine ends.

When the condition is not satisfied in Step S301, determination of a white line is performed again in Step S303. In Step S303, it is determined whether a condition that there is no white line crossing a lane in the other lane and there is a white line crossing a lane in the traveling lane is satisfied.

When the condition is satisfied in Step S303, that is, when there is a white line crossing a lane in only the traveling lane, the process of Step S311 is performed. In Step S311, it is determined that the other lane has a higher priority than the traveling lane. Accordingly, the process of Step S3 in the main routine ends.

When the condition is not satisfied in Step S303, that is, when there is no white line in the traveling lane and the other lane or when there is a white line in both lanes, priority determination is not possible depending on whether there is a white line. In this case, the process of Step S304 is performed. In Step S304, information on a lane structure before a junction in the information on constraint conditions acquired in Step S1 is referred to. Then, it is determined whether a condition that there is road facility such as a parking area in the other lane before the junction and there is no road facility in the traveling lane before the junction is satisfied.

When the condition is satisfied in Step S304, that is, when there is road facility in only the other lane before the junction, the process of Step S302 is performed. In Step S302, it is determined that the traveling lane has a higher priority than the other lane. Accordingly, the process of Step S3 in the main routine ends.

When the condition is not satisfied in Step S304, determination of road facility is performed again in Step S305. In Step S305, it is determined whether a condition that there is no road facility such as a parking area in the other lane before the junction and there is road facility in the traveling lane before the junction is satisfied.

When the condition is satisfied in Step S305, that is, when there is road facility in only the traveling lane before the junction, the process of Step S311 is performed. In Step S311, it is determined that the other lane has a higher priority than the traveling lane. Accordingly, the process of Step S3 in the main routine ends.

When the condition is not satisfied in Step S305, that is, when there is no road facility in the traveling lane and the other lane or when there is road facility in both lanes, priority determination is not possible depending on whether there is road facility. In this case, the process of Step S306 is performed. In Step S306, information on traffic regulations for the junction in the information on constraint conditions acquired in Step S1 is referred to again. Then, it is determined whether an arrow for urging joining to the traveling lane is present on the road surface of the other lane.

When the condition is satisfied in Step S306, that is, when an arrow for urging joining to the traveling lane is present on the road surface of the other lane, the process of Step S302 is performed. In Step S302, it is determined that the traveling lane has a higher priority than the other lane. Accordingly, the process of Step S3 in the main routine ends.

When the condition is not satisfied in Step S306, determination of presence of an arrow on the road surface is performed again in Step S307. In Step S307, it is determined whether an arrow for urging joining to the other lane is present on the road surface of the traveling lane.

When the condition is satisfied in Step S307, that is, when an arrow for urging joining to the other lane is present on the road surface of the traveling lane, the process of Step S311 is performed. In Step S311, it is determined that the other lane has a higher priority than the traveling lane. Accordingly, the process of Step S3 in the main routine ends.

When the condition is not satisfied in Step S307, that is, when an arrow is not present on the road surfaces of the traveling lane and the other lane or when an arrow is present on the road surfaces of both lanes, priority determination is not possible depending on whether an arrow is present. In this case, the process of Step S308 is performed. In Step S308, information on a road shape for the junction in the information on constraint conditions acquired in Step S1 is referred to. Then, it is determined whether the road shape of the junction is a road shape in which the other lane approaches the traveling lane.

When the condition is satisfied in Step S308, that is, when the road shape of the junction is a road shape in which the other lane approaches the traveling lane, the process of Step S302 is performed. In Step S302, it is determined that the traveling lane has a higher priority than the other lane. Accordingly, the process of Step S3 in the main routine ends.

When the condition is not satisfied in Step S308, determination of a road shape is performed again in Step S309. In Step S309, it is determined whether the road shape of the junction is a road shape in which the traveling lane approaches the other lane.

When the condition is satisfied in Step S309, that is, when the road shape of the junction is a road shape in which the traveling lane approaches the other lane, the process of Step S311 is performed. In Step S311, it is determined that the other lane has a higher priority than the traveling lane. Accordingly, the process of Step S3 in the main routine ends.

When the condition is not satisfied in Step S309, that is, when the road shape of the junction is a road shape in which the traveling lane and the other lane merge to approach each other on equal terms, priority determination is not possible based on a road shape. In this case, the process of Step S310 is performed. In Step S310, it is determined that the traveling lane and the other lane have the same priority. Accordingly, the process of Step S3 in the main routine ends.

In the above-mentioned examples of the priority determining process, the priorities are determined in the order of determination based on a white line crossing a lane in traffic regulations, determination based on a lane structure before a junction, determination based on presence of an arrow on the road surface in traffic regulations, and determination based on a road shape of a junction. Accordingly, for example, when the priority determined based on a road shape is conflicted with the priority determined based on presence of an arrow on the road surface, the priority determined based on presence of an arrow on the road surface has precedence. When the priority determined based on presence of an arrow on the road surface is conflicted with the priority determined based on a white line crossing a lane, the priority determined based on a white line crossing a lane has precedence. In this way, by giving a priority to determination criteria for priority determination, it is possible to determine a priority with high reliability based on a combination of a plurality of types of information.

Description will be continuously made with reference back to the main routine illustrated in FIG. 9. When it is determined in Step S2 that there is no information on constraint conditions required for priority determination, the process of Step S6 is performed. In Step S6, the priority determining process is not performed and the priorities of the traveling lane and the other lane are considered to be equal to each other.

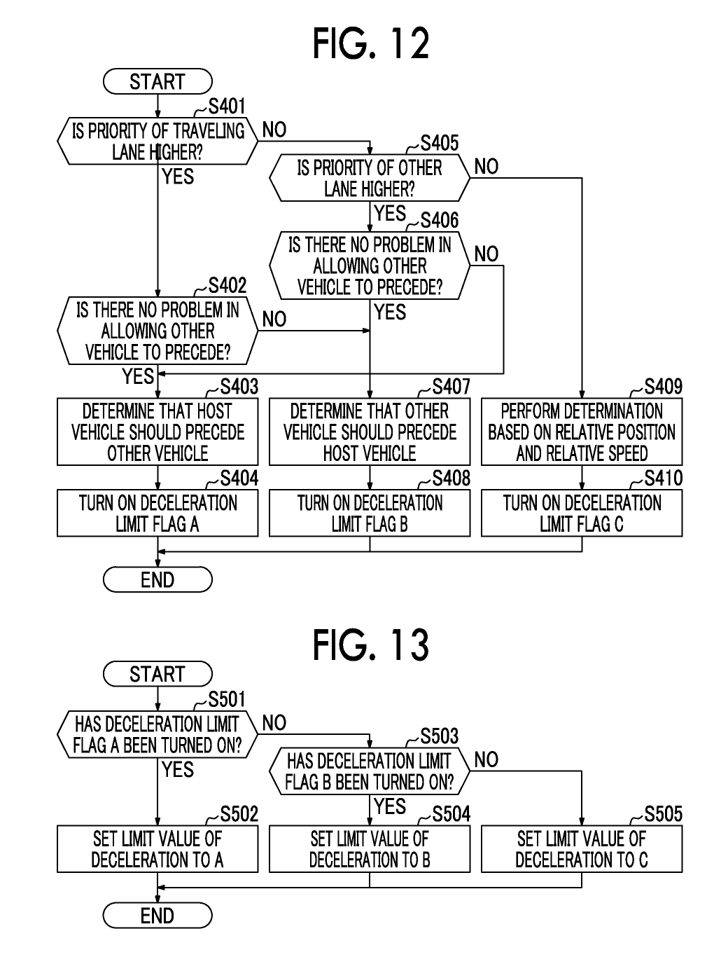

After the process of Step S3 and after the process of Step S6, a behavior determining process is performed in Step S4. Specifically, in Step S4, a subroutine illustrated in FIG. 12 is performed by the ECU 7. The subroutine illustrated in FIG. 12 is an example of the behavior determining process which is performed in Step S4.

In the subroutine illustrated in FIG. 12, first, in Step S401, it is determined whether determination of that the other lane has a higher priority than the traveling lane (the traveling lane has a lower priority than the other lane) has been performed. When the traveling lane has a higher priority, the process of Step S402 is performed. In Step S402, it is determined whether there is a problem in preceding of the host vehicle based on a relative relationship between the other vehicle traveling on the other lane and the host vehicle. For example, when the traveling speed of the other vehicle is high, there is concern of collision when the host vehicle enters the front of the other vehicle, or an escape behavior or sudden behavior change for avoiding collision with the other vehicle is required, it is determined that there is a problem in preceding of the host vehicle.

When there is no problem in preceding of the host vehicle, the process of Step S403 is selected. In Step S403, behavior determination that the host vehicle should precede the other vehicle is performed. In Step S404, a deceleration limit flag A is turned on. The deceleration limit flag A is used for determination in the subroutine which is performed in Step S5 which will be described later. Accordingly, the process of Step S4 in the main routine ends.

On the other hand, when there is a problem in preceding of the host vehicle, the process of Step S407 is selected. In Step S407, behavior determination that the other vehicle should precede the host vehicle is performed. In Step S408, a deceleration limit flag B is turned on. The deceleration limit flag B is used for determination in the subroutine which is performed in Step S5 which will be described later. Accordingly, the process of Step S4 in the main routine ends.

When the condition is not satisfied in Step S401, that is, when the priority of the traveling lane is not high, it is determined whether it has been determined in Step S405 that the other lane has a higher priority than the traveling lane (the traveling lane has a lower priority than the other lane). When the priority of the other lane is higher, the process of Step S406 is performed. In Step S406, it is determined whether there is a problem in preceding of the other vehicle traveling on the other lane based on the relative relationship between the other vehicle and the host vehicle. For example, when the traveling speed of the other vehicle is low and there is concern of collision when the host vehicle enters behind the other vehicle, it is determined that there is a problem in preceding of the other vehicle.

On the other hand, when there is no problem in preceding of the other vehicle, behavior determination that the other vehicle should precede the host vehicle is performed in Step S407. In Step S408, the deceleration limit flag B is turned on. Accordingly, the process of Step S4 in the main routine ends.

On the other hand, when there is a problem in preceding of the other vehicle, behavior determination that the host vehicle should precede the other vehicle is performed in Step S403. In Step S404, the deceleration limit flag A is turned on. Accordingly, the process of Step S4 in the main routine ends.

When the condition is not satisfied in Step S405, that is, when the traveling lane and the other lane have the same priority, the process of Step S409 is selected. The case in which the traveling lane and the other lane have the same priority is a case in which the process of Step S6 is selected or a case in which the process of Step S310 is selected. In Step S409, behavior determination that a preceding vehicle should be determined based on the relative relationship between the other vehicle traveling on the other lane and the host vehicle, for example, a relative position and a relative speed, is performed. In Step S410, a deceleration limit flag C is turned on. The deceleration limit flag C is used for determination in the subroutine which is performed in Step S5 which will be described later. Accordingly, the process of Step S4 in the main routine ends.

Description will be continuously made with reference back to the main routine illustrated in FIG. 9. After the behavior determining process, a behavior is executed in Step S5. In Step S5, the ECU 7 transmits a control command value to the actuator 9 and the notification unit 8 based on the behavior determination result of Step S4. For example, when behavior determination that the host vehicle should precede has been performed, the actuator 9 is controlled so that the host vehicle enters the front of the other vehicle traveling on the other lane, and the notification unit 8 is controlled so that the other vehicle entering behind the host vehicle is notified of the behavior determination result of the host vehicle. On the other hand, when behavior determination that the other vehicle traveling on the other lane should precede has been performed, the actuator 9 is controlled so that the other vehicle enters the front of the host vehicle, and the notification unit 8 is controlled so that the other vehicle entering the front of the host vehicle is notified of the behavior determination result of the host vehicle.

Specifically, in Step S5, the deceleration of the host vehicle at the time of joining is limited based on the behavior determination result in order to realize a smooth operation of the host vehicle in the junction. For example, a limit value of the deceleration of the host vehicle at the time of joining is set based on the behavior determination result, and the actuator is controlled so that the host vehicle decelerates at a constant deceleration which is not higher than the limit value. The subroutine illustrated in FIG. 13 is an example of a deceleration limiting process which is performed by the ECU 7 in Step S5.

In the subroutine illustrated in FIG. 13, first, in Step S501, it is determined whether the deceleration limit flag A is turned on. The deceleration limit flag A is turned on when behavior determination that the host vehicle should precede the other vehicle traveling on the other lane has been performed in Step S4. When the deceleration limit flag A is turned on, the limit value of the deceleration of the host vehicle is set to a predetermined value A in Step S502.

When the deceleration limit flag A is not turned on, it is determined in Step S503 whether the deceleration limit flag B is turned on. The deceleration limit flag B is turned on when behavior determination that the other vehicle traveling on the other lane should precede the host vehicle has been performed in Step S4. When the deceleration limit flag B is turned on, the limit value of the deceleration of the host vehicle is set to a predetermined value B in Step S504.

When neither the deceleration limit flag A nor the deceleration limit flag B are turned on, that is, when the deceleration limit flag C is turned on, the limit value of the deceleration of the host vehicle is set to a predetermined value C in Step S505.

The predetermined values A, B, and C are set to satisfy a relationship of A<B<C. According to this relationship, the limit value of the deceleration of the host vehicle when the traveling lane has a higher priority is the smallest. In a situation in which the host vehicle should precede the other vehicle traveling on the other lane, a vehicle on the traveling lane on which the host vehicle is traveling travels smoothly. Accordingly, when strong deceleration is performed, there is concern that a distance from the following vehicle will decrease excessively. In order to curb this situation, the limit value of the deceleration of the host vehicle when the traveling lane has a higher priority is set to be small. According to the relationship, the limit value of the deceleration of the host vehicle when the traveling lane and the other lane have the same priority is large. When the priorities are equal, there is a likelihood that the other vehicle traveling on the other lane will merge with consideration that the other vehicle has a higher priority. In this case, there is a likelihood that behavior change of the host vehicle will be required immediately before joining depending on the relationship with the behavior of the other vehicle. Accordingly, the limit value of the deceleration of the host vehicle when the priorities are equal is set to be large so that the host vehicle can satisfactorily avoid the joining other vehicle. In the relationship of the predetermined values A, B, and C, when the predetermined value A is the smallest, the predetermined value B and the predetermined value C may be equal to each other or may have a reverse relationship.

According to the above-mentioned joining control, the priorities of the traveling lane and the other lane in the junction are determined depending on the actual state of the junction based on the information on traffic constraint conditions which are imposed upon a vehicle entering the junction such as the information on traffic regulations, information on the road shape, and information on the lane structure. Accordingly, it is possible to appropriately determine whether the host vehicle should precede the other vehicle and to realize a smooth traffic flow in the junction by controlling driving of the host vehicle based on the determination result.

### 5. Modified Examples

In the priority determining process illustrated in FIG. 11, it may be determined whether a white line is a solid line or a dotted line whether the thickness of a white line is equal to or greater than a threshold value in addition to or instead of determination that a white line crossing a lane is present. In addition to or instead of such determination, determination based on indication details of a road signboard may be performed.

In the priority determining process illustrated in FIG. 11, all of the information on traffic regulations, information on the road shape, and information on the lane structure have been used for priority determination, but at least one of three types of information has only to be used. For example, when the information on traffic regulations cannot be acquired due to detection abnormality of the camera 4, data damage of the map information unit 3, or the like, the priority determination may be performed based on other available information such as information on the road shape and information on the lane structure. In this case, in FIG. 11, Steps S301 and S303 are skipped and the priority determining process is started from the process of Step S304. According to this modified example, even when information on some constraint conditions cannot be acquired, the priority determination can be performed using the available other information and thus it is possible to apply the priority determination to various situations.

In the behavior determining process illustrated in FIG. 12, Step S402 of determining whether there is a problem in preceding of the host vehicle and step S406 of determining whether there is a problem in preceding of the other vehicle may be skipped. That is, it may be possible to determine which of the host vehicle and the other vehicle should precede simply based on only the priorities.

In the behavior determining process illustrated in FIG. 12, when it is determined that there is a problem in preceding of the host vehicle, the other vehicle is made to precede. However, when there is a problem in preceding of the host vehicle, the routine may be switched to collision avoidance control which is performed in a routine other than the joining control. Alternatively, after an occupant of the vehicle 10 has been notified, switching to manual driving may be performed. For example, when the relative distance from the other vehicle is less than a predetermined threshold value and the relative speed is equal to or higher than a predetermined threshold value, it is determined that a risk of collision is high and switching to other control or switching to manual driving may be performed as described above. By performing such control, it is possible to appropriately cope with a case in which a risk cannot be avoided by normal joining control. The same is true when it is determined that there is a problem in preceding of the other vehicle.

A vehicle controller according to an aspect of the disclosure is for a vehicle that is able to travel autonomously in a junction at which a traveling lane and another lane join. The vehicle controller includes an electronic control unit configured to: acquire constraint condition information on traffic constraint conditions that are imposed on a vehicle entering the junction; perform a priority determining process of determining priorities of the traveling lane and the other lane in the junction based on the constraint condition information, perform a behavior determining process of determining whether to cause a host vehicle to precede another vehicle traveling on the other lane based on the priorities; and control the host vehicle based on the constraint condition information.

In the aspect, the electronic control unit may be configured to control the host vehicle based on a result output in the behavior determining process. The electronic control unit may be configured to control a speed of the host vehicle in the junction.

One factor for determining which of the host vehicle and the other vehicle is to precede the other at the junction is traffic constraint conditions which are imposed upon a vehicle entering the junction. In the vehicle controller according to the disclosure, since the priorities of the traveling lane and the other lane are determined based on the constraint conditions, it is possible to appropriately determine whether the host vehicle is to precede the other vehicle in the junction.

In the aspect, the electronic control unit may be configured to limit deceleration more when the priority of the traveling lane is higher than the priority of the other lane than when the priority of the other lane is higher than the priority of the traveling lane. Accordingly, when the host vehicle travels on a lane with a higher priority, the host vehicle can travel adaptively with respect to a nearby traffic flow and it is thus possible to prevent a distance from a following vehicle from become excessively short.

The constraint conditions include legal constraint conditions and physical constraint conditions. Therefore, in the aspect, the electronic control unit may be configured to acquire at least information on traffic regulations for the junction as the constraint condition information. Traffic regulations for a junction correspond to the legal constraint conditions. By considering the legal constraint conditions in determination of the priorities, it is possible to realize a smooth traffic flow in the junction without violating the regulations. Here, the information on traffic regulations for the junction may not be a traffic regulation for directly determining priorities and has only to allow determination of priorities at least in a combination with other information.

In the aspect, the electronic control unit may be configured to acquire at least information on a road shape of the junction as the constraint condition information. The electronic control unit may be configured to acquire, as the constraint condition information, at least information on lane structures of the traveling lane and the other lane before the junction. The road shape of the junction or the lane structure before the junction corresponds to the physical constraint conditions. By considering the physical constraint conditions in determination of the priorities, it is possible to realize a smooth traffic flow in the junction without forcing the host vehicle or the other vehicle to adopt unreasonable behavior.

In the aspect, the electronic control unit may be configured to acquire a plurality of types of information including at least information on traffic regulations for the junction as the constraint condition information. And, the electronic control unit may be configured to determine the priorities based on a combination of the plurality of types of information in the priority determining process. In this case, the electronic control unit may be configured to determine the priorities based on a combination of the plurality of types of information in the priority determining process. According to this configuration, it is possible to determine priorities with high reliability based on a combination of a plurality of types of information.

In the aspect, the electronic control unit may be configured to determine the priorities based on some types of information when the constraint condition information acquired is some of the plurality of types of information in the priority determining process. According to this configuration, even when some types of information cannot be acquired, it is possible to determine priorities. For example, when information on traffic regulations for the junction cannot be acquired, the priorities may be determined based on only information on physical constraint conditions such as information on a road shape of the junction.

In the aspect, the electronic control unit may be configured to acquire a plurality of types of information as the constraint condition information. And, the electronic control unit may be configured to determine the priorities based on at least one of the plurality of types of information in the priority determining process.

In the aspect, the vehicle controller may further include a first sensor configured to acquire other vehicle information on a relative relationship between the other vehicle and the host vehicle. The electronic control unit may be configured to determine whether to cause the host vehicle to precede the other vehicle based on the other vehicle information acquired by the first sensor and the priorities in the behavior determining process. In this case, the electronic control unit may be configured to determine whether the host vehicle is to precede the other vehicle based on the other vehicle information acquired by the first sensor and the priorities in the behavior determining process. By considering the relative relationship with the other vehicle in addition to the priorities which are determined based on the traffic constraint conditions, it is possible to appropriately determine whether the host vehicle is to precede the other vehicle.

In the above aspect, the vehicle controller may further include a second sensor configured to recognize obstacle information on at least one of an obstacle on the traveling lane and an obstacle on the other lane. The electronic control unit may be configured to acquire information on a shape of the junction as the constraint condition information based on the obstacle information.

In the above aspect, the electronic control unit may be configured to acquire, as the constraint condition information, a boundary line between the traveling lane and the other lane and two side lines of a lane into which the traveling lane and the other lane merge. And, the electronic control unit may be configured to: calculate a first distance between one of the two side lines and the boundary line and a second distance between the other of the two side lines and the boundary line; and determine the priorities based on the first distance and the second distance.

In the above aspect, the vehicle controller may further include a second sensor configured to recognize obstacle information on at least one of an obstacle on the traveling lane and an obstacle on the other lane. The electronic control unit may be configured to acquire information on a shape of the junction as the constraint condition information based on the obstacle information, the information on the shape of the junction including two side lines of a lane into which the traveling lane and the other lane merge. The electronic control unit may be configured to acquire a boundary line between the traveling lane and the other lane as the constraint condition information. The electronic control unit may be configured to: calculate a first distance between one of the two side lines and the boundary line and a second distance between the other of the two side lines and the boundary line; and determine the priorities based on the first distance and the second distance.

In the above aspect, the vehicle controller may further include a constraint condition information acquiring device configured to acquire the constraint condition information acquiring information, wherein the electronic control unit is configured to acquire the constraint condition information by using the constraint condition information acquiring device.

As described above, in the vehicle controller according to the disclosure, since the priorities of the traveling lane and the other lane in the junction are determined based on the traffic constraint conditions which are imposed upon a vehicle entering the junction, it is possible to appropriately determine whether the host vehicle is to precede the other vehicle in the junction and to realize a smooth traffic flow in the junction.

What is claimed is:

1. A vehicle controller for a vehicle that is able to travel autonomously in a junction at which a traveling lane and another lane join, the vehicle controller comprising
an electronic control unit configured to:
acquire constraint condition information on traffic constraint conditions that are imposed on a vehicle entering the junction;
perform a priority determining process of determining priorities of the traveling lane and the other lane in the junction based on the constraint condition information,
perform a behavior determining process of determining whether to cause a host vehicle to precede another vehicle traveling on the other lane based on the priorities; and
control the host vehicle based on the constraint condition information.

2. The vehicle controller according to claim 1, wherein the electronic control unit is configured to control the host vehicle based on a result output in the behavior determining process.

3. The vehicle controller according to claim 1, wherein the electronic control unit is configured to control a speed of the host vehicle in the junction.

4. The vehicle controller according to claim 1, wherein the electronic control unit is configured to limit deceleration more when the priority of the traveling lane is higher than the priority of the other lane than when the priority of the other lane is higher than the priority of the traveling lane.

5. The vehicle controller according to claim 1, wherein the electronic control unit is configured to acquire at least information on traffic regulations for the junction as the constraint condition information.

6. The vehicle controller according to claim 1, wherein the electronic control unit is configured to acquire at least information on a road shape of the junction as the constraint condition information.

7. The vehicle controller according to claim 1, wherein the electronic control unit is configured to acquire, as the constraint condition information, at least information on lane structures of the traveling lane and the other lane before the junction.

8. The vehicle controller according to claim 1, wherein
the electronic control unit is configured to acquire a plurality of types of information including at least information on traffic regulations for the junction as the constraint condition information, and
the electronic control unit is configured to determine the priorities based on a combination of the plurality of types of information in the priority determining process.

9. The vehicle controller according to claim 8, wherein the electronic control unit is configured to determine the priorities based on some types of information when the constraint condition information acquired is some of the plurality of types of information in the priority determining process.

10. The vehicle controller according to claim 1, wherein
the electronic control unit is configured to acquire a plurality of types of information as the constraint condition information, and the electronic control unit is configured to determine the priorities based on at least one of the plurality of types of information in the priority determining process.

11. The vehicle controller according to claim 1, further comprising a first sensor configured to acquire other vehicle information on a relative relationship between the other vehicle and the host vehicle, wherein
the electronic control unit is configured to determine whether to cause the host vehicle to precede the other vehicle based on the other vehicle information acquired by the first sensor and the priorities in the behavior determining process.

12. The vehicle controller according to claim 1, further comprising a second sensor configured to recognize obstacle information on at least one of an obstacle on the traveling lane and an obstacle on the other lane, wherein
the electronic control unit is configured to acquire information on a shape of the junction as the constraint condition information based on the obstacle information.

13. The vehicle controller according to claim 1, wherein
the electronic control unit is configured to acquire, as the constraint condition information, a boundary line between the traveling lane and the other lane and two side lines of a lane into which the traveling lane and the other lane merge, and
the electronic control unit is configured to:
calculate a first distance between one of the two side lines and the boundary line and a second distance between the other of the two side lines and the boundary line; and
determine the priorities based on the first distance and the second distance.

14. The vehicle controller according to claim 1, further comprising a second sensor configured to recognize obstacle information on at least one of an obstacle on the traveling lane and an obstacle on the other lane, wherein
the electronic control unit is configured to acquire information on a shape of the junction as the constraint condition information based on the obstacle information, the information on the shape of the junction including two side lines of a lane into which the traveling lane and the other lane merge,
the electronic control unit is configured to acquire a boundary line between the traveling lane and the other lane as the constraint condition information, and
the electronic control unit is configured to:
calculate a first distance between one of the two side lines and the boundary line and a second distance between the other of the two side lines and the boundary line; and
determine the priorities based on the first distance and the second distance.

15. The vehicle controller according to claim 1, further comprising
a constraint condition information acquiring device configured to acquire the constraint condition information acquiring information, wherein
the electronic control unit is configured to acquire the constraint condition information by using the constraint condition information acquiring device.
